(19) United States
(12) Patent Application Publication
(10) Pub. No.: US 2018/0349921 A1
(43) Pub. Date: Dec. 6, 2018

(54) Method to Predict the Near-term Direction of Volatility

(71) Applicant: Richard Davidian, New York, NY (US)

(72) Inventor: Richard Davidian, New York, NY (US)

(21) Appl. No.: 15/613,863

(22) Filed: Jun. 5, 2017

(51) Int. Cl. G06Q 30/02; G06Q 40/04; G06Q 40/06; G06N 3/02

(52) U.S. Cl. CPC G06Q 30/02; G06N 3/02; G06Q 40/06; G06Q 40/04

(57) ABSTRACT

A method to predict the near-term direction of the volatility of assets, be those assets markets such as the stock, bond, commodity or currency markets, or individual securities, be they individual stocks, bonds, commodities, or currencies, and/or futures or options on any of those assets or securities, by applying a set of rules that use technical factors as inputs, including but not limited to such factors as the return of price levels of said assets or securities, the daily and weekly returns of the volatility of said assets or securities and the absolute level of volatility of said assets or securities.

### BACKGROUND

One of the key metrics used to measure risk in the stock market is volatility. The historical volatility is often calculated as the standard deviation of the returns. A measure, known as the VIX Index, is also a measure of volatility. It is calculated by the CBOE (Chicago Board Options Exchange). The calculation uses the implied volatilities of Standard and Poor's 500 Index options, weighted according to a formula available at the CBOE.

Knowing whether volatility will move higher or lower is of critical importance. Many financial entities, including banks, insurance companies, pension funds, hedge funds, et cetera, use volatility as an input to their risk measures, such as VaR (Value at Risk). Therefore knowing which direction volatility is moving, higher or lower, can give an idea if risk will be increasing or decreasing. Institutions and individuals could use this information to better manage risk and hedge their exposures. As well, many players in the financial markets could use this information to profit in any number of ways.

### DETAILED DESCRIPTION

It is important to note here a distinguishing feature of the method claimed herein is that it predicts the near-term direction of volatility, not the absolute level of volatility. Using this method, we can determine if volatility is moving higher or lower, but we can not say with certainty that it should be at any particular level.

The method claimed herein incorporates the fact that volatility clusters. What is meant by this is that quiet markets tend to be followed by quiet markets, and volatile markets tend to be followed by volatile markets. Said another way, volatility begets volatility. Mathematically, we would say that volatility has memory, or that it shows auto-correlation. One can find discussions at length of these concepts in the literature, in particular see Mandelbrot, “The Misbehavior of Markets.” The method claimed herein also incorporates the fact that volatility is mean-reverting. That is, volatility can not continually go up, or continually go down.

The method claimed herein applies to asset classes, markets, and individual securities. As one example, in the case of the Equity Stock Market, and in particular for the asset that is the S&P500 Index, the method claimed herein uses the VIX Index and futures on the VIX Index as the measure of volatility. The one-week return of VIX futures is calculated and the rule set given in claim 1 below applied, to determine if volatility is going to subsequently increase or decrease for the S&P500.

What is claimed is:

1. A method to predict whether the volatility of an asset will subsequently increase or decrease from the Measurement Date (MD), comprising the steps of:
a. Calculate the one week return of the volatility of the asset as measured on the MD
b. Apply the following set of rules to said one week return
i. If said one week return is greater than a threshold of 15%, the volatility of the asset will subsequently decrease
ii. If said one week return is greater than a threshold of 5% but less than or equal to a threshold of 15%, the volatility of the asset will subsequently increase
iii. If said one week return is greater than a threshold of minus 8% but less than or equal to a threshold of positive 5%, the volatility of the asset will subsequently decrease
iv. If said one week return is less than or equal to a threshold of minus 8%, the volatility of the asset will subsequently increase

2. The method of claim 1, whereby the exact rule thresholds as set forth in 1bi through 1biv, above, are altered, leading to a better or worse predictive ability.

3. The method of claim 1, additionally incorporating daily returns of the volatility of the asset, in an attempt to improve or otherwise alter the results of said method.

4. The method of claim 1, additionally incorporating the absolute level of the volatility of the asset, in an attempt to improve or otherwise alter the results of said method.

5. The method of claim 1, additionally incorporating daily and weekly returns of the price of the asset itself, as opposed to the volatility of the asset, in an attempt to improve or otherwise alter the results of said method.

6. The method of claim 1, additionally incorporating volume traded, in an attempt to improve or otherwise alter the results of said method.

7. The method of claim 1, applied to the Stock Market.

8. The method of claim 1, applied to the Standard and Poors 500 Index (S&P500).

9. The method of claim 1, applied to the Bond Market.

10. The method of claim 1, applied to the Commodities Market.

11. The method of claim 1, applied to the Foreign Exchange market.

12. The method of claim 1, applied to any individual security, be it stock, bond, currency or commodity, and/or futures and/or options on any of those securities

13. The method of claim 1, used to make profit by trading futures.

14. The method of claim 1, used to make profit by trading options.

15. The method of claim 1, used to make profit by trading any combination of VIX futures, S&P500 futures, VIX options and/or S&P500 options

16. The method of claim 1, used to determine when risk is increasing and when risk is decreasing.

17. The method of claim 1, used to buy or sell individual securities, be they stocks, bonds, commodities or currencies, and/or futures and/or options on any of the above securities, whose performance is impacted when volatility is increasing.

18. The method of claim 1, used to buy or sell individual securities, be they stocks, bonds, commodities or currencies, and/or futures and/or options on any of the above securities, whose performance is impacted when volatility is decreasing.

19. A method that uses daily and/or weekly returns of the volatility of an asset to predict whether the volatility of said asset will subsequently increase or decrease.

20. The method of claim 19, that also incorporates other technical factors, including but not limited to the level of volatility, daily and/or weekly returns of the underlying asset itself, volume traded of the asset itself or of the volatility instrument itself.
